(19) United States
(12) Patent Application Publication
(10) Pub. No.: US 2010/0189497 A1
(43) Pub. Date: Jul. 29, 2010

(54) FLEXIBLE HINGE IN TRAFFIC CONTROL MARKER

(76) Inventor: Robert K. Hughes, SR., Fort Myers, FL (US)

Correspondence Address: BRACEWELL & GIULIANI LLP, P.O. BOX 61389, HOUSTON, TX, 77208-1389, US

(21) Appl. No.: 12/561,889

(22) Filed: Sep. 17, 2009

Related U.S. Application Data
(60) Provisional application No. 61/146,873, filed on Jan. 23, 2009.

(51) Int. Cl. E01F 9/087; E05D 1/00

(52) U.S. Cl. 404/12; 16/225

(57) ABSTRACT

A stiffening element located within a flexible hinge on a roadway marker for increasing the stiffness of the hinge and resiliency of the roadway marker. The stiffening element provides more spring to return the roadway marker back to a substantially erect position after being deflected, for example, by a vehicle. The stiffening element can be a formed from a hard material such as PVC and can have the shape of a ball, cylinder, puck, oblong, or other suitable shape.

### BACKGROUND OF THE INVENTION

1. Technical Field

The present invention relates in general to traffic control markers and, in particular, to a traffic control marker having an adjustable system, method and apparatus for strengthening a flexible hinge thereof.

2. Description of the Related Art

Traffic control devices used on roadways or other marking areas are frequently struck by vehicles. Examples of commonly used traffic control devices include traffic cones. If the traffic control device is not adequately secured in place, the device is often displaced from its intended location. To prevent inadvertent displacement of traffic control devices, a traffic control device is needed that remains in place even when struck by a vehicle.

Another type of traffic control device is a flexible, strap-like highway marker that is secured within a base. Such traffic control devices, however, feature many parts and require multiple steps to properly assemble and install the traffic control device. Additionally, each of the parts included in such devices is naturally subject to wear over time. Thus, it would be desirable to provide a flexible highway marker with a flexible hinge that is adjustable for supporting various types and weights of markers and signage, as well as maintain the performance of flexible highway markers when vehicles deflect them on the roadway or other marking area.

### SUMMARY OF THE INVENTION

In an embodiment of the present technique, a roadway marker comprising a base, a flexible hinge connected to the base, a stiffening element, and a flexible marker connected to the member and protruding upward, is presented. The roadway marker allows for effective warning of automobile drivers of the conditions of the roadway. When impacted, the roadway marker is not substantially displaced from its previous intended position. The stiffening element within the flexible hinge, advantageously prevents the hinge from collapsing when the marker is struck by a vehicle and bent, and provides additional spring to return the roadway marker to a substantially erect position. The stiffening element can have various shapes, including a ball, a puck, a cylinder, or oblong. The stiffening element may be formed from a resilient or hard material such as plastic, rubber, PVC pipe segments. Additionally, the stiffening element within the flexible hinge provides more strength and resiliency to the roadway marker.

### BRIEF DESCRIPTION OF THE DRAWINGS

So that the manner in which the features and advantages of the present invention are attained and can be understood in more detail, a more particular description of the invention may be had by reference to the embodiments thereof that are illustrated in the appended drawings. However, the drawings illustrate only some embodiments of the invention and therefore are not to be considered limiting of its scope as the invention may admit to other equally effective embodiments.

FIG. 1 is a schematic sectional side views of a traffic marker known in the prior art, having no stiffening features in its hinge.

FIGS. 2-6 are schematic sectional side views of various embodiments of traffic markers constructed in accordance with the invention showing, in solid lines, the traffic markers when erect and undeflected, and, in dashed lines, the traffic markers when deflected.

### DETAILED DESCRIPTION OF THE INVENTION

Although the following detailed description contains many specific details for purposes of illustration, those of ordinary skill in the art will appreciate that many variations and alterations to the following details are within the scope of the invention. Accordingly, the exemplary embodiments of the invention described below are set forth without any loss of generality to and without imposing limitations on the claimed invention.

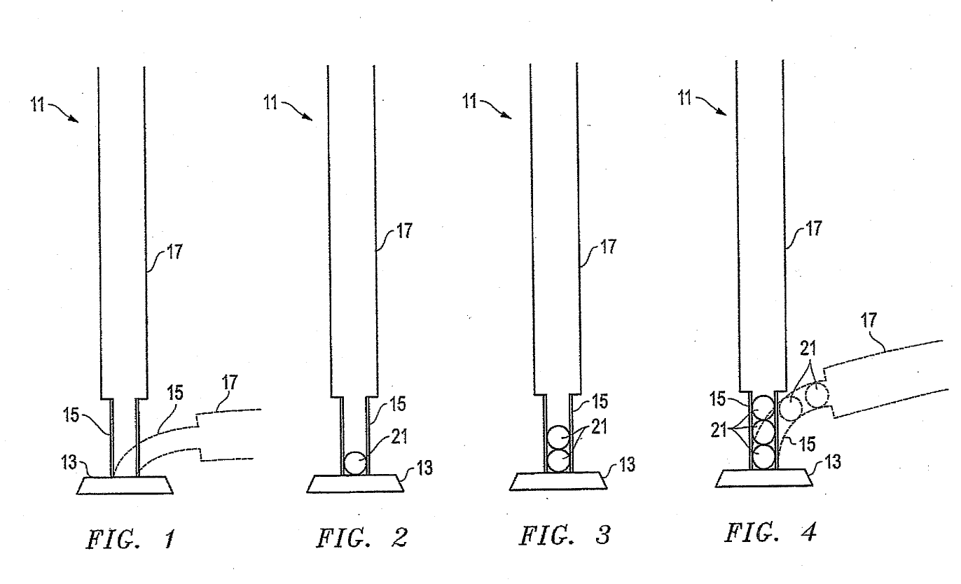

FIGS. 1-4 illustrate various embodiments of a system, method and apparatus for a traffic control marker constructed in accordance with the invention. A traffic control assembly 11 for marking roadways or other marking areas generally includes a base 13, a hinge 15, and a marker 17. Signage may be placed on or affixed to traffic control assembly 11 (e.g., to marker 17) as is known by those of ordinary skill in the art.

The base 13 may comprise a dense or rigid material, and shaped in various configurations including, for example, a flat cylinder, conical, or frustoconical shapes as shown. Alternatively, base 13 may be configured in square or rectangular shapes, or any other suitable shape depending on the application. For example, the base may comprise other profiles, such as elongated oval or still other shapes. These various shapes may be suitable for uneven terrain to better stabilize the stake when the surface of the supporting ground is not level. For example, on a roadway having a sloped shoulder, a base with an elongated shape (e.g., an oval shape, approximately 4 inches by 18 inches) and with the long side of the base parallel to the roadway, may be used to better follow the contour of the shoulder in which the marker is located. The base 13 is designed to be secured to a roadway, parking lot, or other traffic area with hardware or adhesives as is known by those of ordinary skill in the art.

In one embodiment (not shown), the base 13 includes holes that are spaced apart about its outer circumference. The holes provide an alternate mounting option for the base to a roadway or other marking area with fasteners. The holes may receive fasteners, such as screws, for mounting the base to the roadway. Alternatively, the base also may be mounted to the roadway with an adhesive, such as epoxy applied to its underside thereof, whereby the adhesive fills the holes when the underside of the base is installed on a roadway.

Both hinge 15 and marker 17 may be formed from different flexible materials. For example, hinge 15 may be formed from a cylindrically tubular member (e.g., urethane), while marker 17 may be formed from a flat sheet of a semi-rigid substrate with reflective material attached thereto. Marker 17 also is capable of supporting other signage, indicators, or the like as is known by those of ordinary skill in the art. Marker 17 can support such signage without appreciably deforming during normal use.

In an erect and undeflected position (i.e., shown in solid lines), base 13 is substantially horizontal after being installed in a traffic area, while hinge 15 and marker 17 extend substantially vertically from the base 13 when in a non-impacted and non-deformed state. In one embodiment, which is one of many possible embodiments, the marker 17 has a vertically-extending length of about 3 feet, and a thickness of about 3 or 4 inches in an elongated cylindrical and/or conical profile. The marker 17 may comprise greater lengths, and may comprise a visibly coated warning device. When placed on a roadway, the base 13 is designed to support the marker 17 in an upright position during normal non-impacted use, and thus alert automobile drivers of roadway conditions. The marker 17 may have a smooth outer surface, or alternatively may be ribbed with longitudinal stiffening ribs along its length. The marker 17 also may be flat, curved, oblong, or tubular in shape.

The hinge 15 and marker 17 are sufficiently thick to resist casual bending or flexing along their lengths from naturally-occurring forces such as winds. As such, the hinge 15 and marker 17 remain substantially vertically upright when in a non-deformed state when they are not forcibly impacted by a physical object. The hinge 15 and marker 17 are sufficiently flexible so that they will elastically deform along their lengths when a physical object forcibly applies a significant impact to them, such as by a moving vehicle or automobile.

FIG. 1 shows the prior art wherein the hinge 15 is hollow and does not contain any stiffening features. The dashed lines of FIG. 1 depict the non-stiffened hinge 15 and marker 17 in a deflected position after impact. Strength and resiliency is limited in the prior art hinge 15 due to the lack of stiffening features.

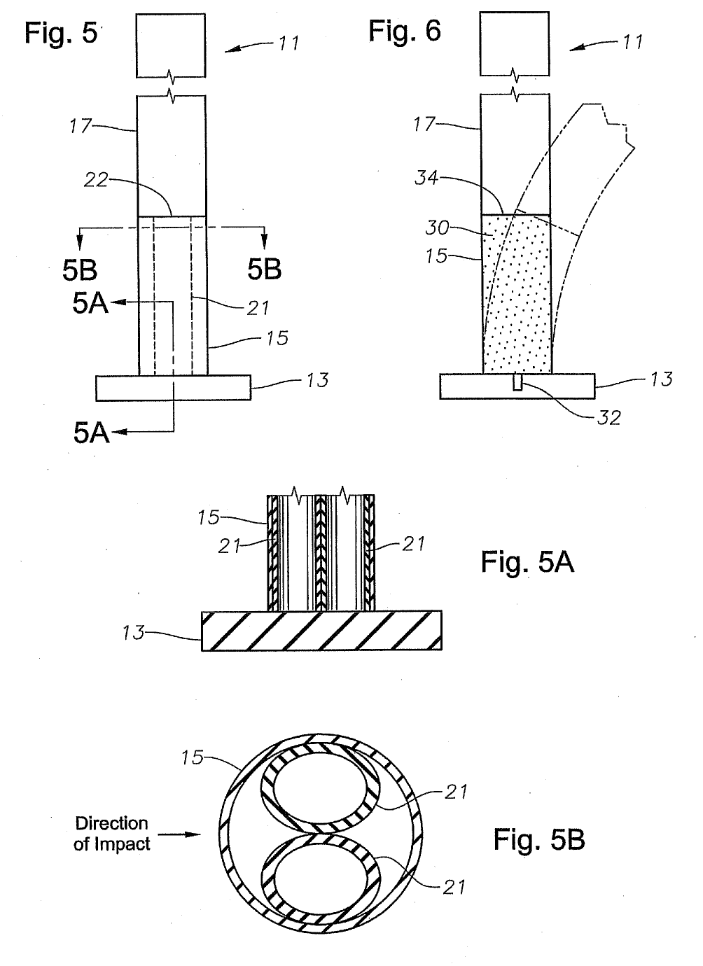

FIGS. 2-6 depict various embodiments of traffic control markers 11 having different bending strengths and resiliency for returning marker 17 to the upright and vertical position after impact. In FIG. 2, the hinge 15 is preferably cylindrical and contains one embodiment of a single stiffening element 21 (e.g., a spherical ball) that is located inside the hinge 15. Stiffening element 21 may be formed from a resilient or hard material such as plastic, rubber, PVC pipe segments, etc. Although stiffening element 21 is depicted as a ball, it may comprise many other shapes (e.g., a puck, a cylinder, oblong, etc.). Moreover, although the size of stiffening element 21 is depicted as filling approximately one-third of the axial length of hinge 15, it may be larger or smaller, depending on the application. Preferably, the diameter of stiffening element 21 is at least equal to the inner diameter of hinge 15. Preferably, stiffening element 21 is free to move along the axis of the hinge 15 and is not fastened to hinge 15.

The presence of stiffening element 21 deters the hinge 15 from collapsing when the traffic control device is bent. Furthermore, stiffening element 21 may be provided at a thickness or diameter that causes hinge 15 to expand (e.g., stretch) when stiffening element 21 is installed within hinge 15. The stretching of hinge 15 by one or more stiffening element(s) 21 causes hinge 15 to become selectively more resilient and have more spring to return the marker 17 (and, e.g., any signage) to the erect or substantially erect position.

Referring now to FIG. 3, another embodiment of the invention includes two stiffening elements 21 located within hinge 15. This embodiment gives the hinge 15 greater strength and resiliency than the prior art shown in FIG. 1 and the illustrated embodiment of FIG. 2. The stiffening elements 21 may be identical or may differ from each other in shape, size, and/or material. Stiffening elements 21 in FIG. 3 may be in contact with each other but preferably are not fastened to each other or to hinge 15. In another embodiment, FIG. 4 depicts hinge 15 containing three stiffening elements 21, which substantially completely fill the interior volume of hinge 15. The cumulative length of the three stiffening elements 21 is the same as the length of the interior of hinge 15. The dashed lines of FIG. 4 also depict the hinge 15 and marker 17 in deflected positions after impact, which unlike the prior art marker shown in FIG. 1, advantageously utilizes stiffening elements 21 to make marker 17 more resilient and capable of returning to a substantially erect, undeflected position after deflection. Further, the embodiment of FIG. 4 provides the hinge 15 with greater strength and resiliency than the preceding embodiments shown in FIGS. 2 and 3. A cap or other retaining feature 22 may be provided with hinge 15 to prevent the one or more stiffening elements 21 from exiting hinge 15 as it is deflected.

Referring to FIGS. 5-5B, another embodiment of the invention preferably includes two upright cylinders as stiffening elements 21 located within hinge 15. The two cylinders are preferably made from rubber and have a combined diameter that causes the hinge 15 to expand (e.g., stretch) when the stiffening elements 21 are installed within hinge 15. The two cylinders comprising the stiffening elements 21 are preferably aligned within hinge such that both cylinders face the direction of impact as shown in FIG. 5B.

In yet another embodiment shown in FIG. 6, the stiffening element 21 within the hinge 15 can be a form of compressed gas 30. A cap or seal 34 within the hinge 15 can contain the gas 30 within to stiffen the hinge 15, making the marker 17 more resilient and aids in the marker 17 returning to a substantially erect position.

In operation, when a moving vehicle (not shown) strikes the traffic control assembly 11, the design permits the hinge 15 and marker 17 to elastically deform before returning to an upright position after impact. When the tire of the vehicle strikes the traffic control assembly 11, the tire rolls onto the conical portion of the base 13 before striking the hinge 15 and marker 17. Upon impact from the tire, the hinge 15 and marker 17 flex or bend. The bottom portion of the flexible marker 17 remains securely affixed to base 13. After the vehicle and tire move past the traffic control assembly 11, the resilient elastic properties of the hinge 15 and marker 17 allow them to return to an upright position. The presence of one or more stiffening elements 21 makes the traffic control assembly 11 even stronger and better able to return to a useful and visible position.

Although the single stiffening element 21 is shown abutting the top of base 13, it is not necessarily required to do so in all embodiments when installed, as it may be located at different positions along the length of hinge 15. In other embodiments, as shown in FIG. 6, the hinge 15 may be sealed with a cap or seal 34 such that it is inflatable with compressed gas or air 30 that can be introduced into the hinge 15 through an inlet port 32. The air pressure at which the hinge is set may be varied depending on the application, to provide the hinge 15 with adequate resiliency to perform for many different sizes and weights of markers 17 and signage. This pressurizable version of the hinge 15 may be used with or without various embodiments of the stiffening elements 21 discussed earlier.

The invention has several important advantages. The traffic control assembly effectively warns automobile drivers of the conditions present on the roadway. When impacted, the traffic control assembly is not substantially displaced from its previous intended position. While providing greater resiliency for the assembly, the invention maintains or improves the performance over conventional flexible highway markers in the industry when vehicles deflect them on the roadway or in other marking areas.

While the invention has been shown or described in only some of its forms, it should be apparent to those of ordinary skill in the art that it is not so limited, but is susceptible to various changes without departing from the scope of the invention.

I claim:

1. A roadway warning apparatus, comprising:
a base;
a tubular, flexible member having a cavity and connected to the base;
a stiffening element located within the cavity of the flexible member; and
a marker connected to the flexible member and protruding upward.

2. The apparatus according to claim 1, wherein the stiffening element comprises a plurality of spherical balls stacked on top of each other.

3. The apparatus according to claim 1, wherein the stiffening element is free to move within the cavity.

4. The apparatus according to claim 1, wherein the stiffening element has a size that causes the member to expand when the stiffening element is installed within the member.

5. The apparatus r according to claim 1, wherein the member has a retainer on its upper end for retaining the stiffening element within cavity of the member.

6. The apparatus according to claim 5, wherein the retainer is a cap.

7. The apparatus according to claim 1, wherein the stiffening element is formed from a hard material and comprises at least one of the following:
a.) a spherical ball; or
b.) a cylinder.

8. The apparatus according to claim 1, wherein the stiffening element is formed from one of the following:
a.) plastic;
b.) rubber; or
c.) polyvinyl chloride.

9. The apparatus according to claim 1, wherein the stiffening element comprises a gas that causes the flexible member to expand when the gas is introduced into the flexible member.

10. A roadway warning apparatus, comprising:
a base;
a flexible hinge connected to the base, the flexible hinge having a hollow interior;
a stiffening element located and free to move a limited amount within the hollow interior of the flexible hinge; and
a marker connected to the flexible hinge and protruding upward.

11. The apparatus according to claim 10, wherein the flexible hinge has a tubular cylindrical shape.

12. The apparatus according to claim 10, wherein the stiffening element has a size that causes the flexible hinge to expand when the stiffening element is installed within the flexible hinge.

13. The apparatus according to claim 10, wherein the flexible hinge has a retainer on at least one end for retaining the stiffening element within the member.

14. The apparatus according to claim 13, wherein the retainer is a cap.

15. The apparatus according to claim 10, wherein the stiffening element is formed from a thermoplastic material and comprises at least one of the following:
a.) a spherical ball; or
b.) a cylinder.

16. The apparatus according to claim 10, wherein the stiffening element comprises a plurality of balls on top of each other within the interior of the hinge.

17. The apparatus according to claim 10, wherein the stiffening element comprises a gas that causes the flexible hinge to expand when the gas is introduced into the flexible hinge.

18. A roadway marker, comprising:
a base;
a flexible hinge connected to the base, the flexible hinge having a tubular cylindrical shape with a hollow interior;
at least one spherical ball located within the hollow interior of the flexible hinge to stiffen the flexible hinge, the ball having a diameter greater than an initial inner diameter of the hinge to cause the flexible hinge to expand when the ball is installed within the flexible hinge; and
a marker connected to the flexible hinge and protruding upward, the marker having reflective sheeting attached to it.

19. The marker according to claim 16, wherein the ball is formed from a thermoplastic material.

20. The marker according to claim 16, further comprising a retainer on a lower end of the flexible hinge to prevent the ball from falling from the hinge while detached from the base.
